(19) United States
(12) Patent Application Publication
(10) Pub. No.: US 2003/0051132 A1
(43) Pub. Date: Mar. 13, 2003

(54) Electronic device with relay function of wireless data communication

(75) Inventors: Takero Kobayashi, Ome-shi (JP); Yasuhiro Ishibashi, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/216,916

(22) Filed: Aug. 13, 2002

(30) Foreign Application Priority Data
Sep. 13, 2001 (JP) 2001-278283

(51) Int. Cl. H04L 9/00

(52) U.S. Cl. 713/153

(57) ABSTRACT

The invention relates to an access point having a function of checking application/non-application of an encryption function in each of radio communication packets, and determining a communication service for a packet on the basis of the application/non-application. The access point has a radio LAN packet process section having a function of checking application/non-application of WEP to a packet received from a radio terminal.

### CROSS-REFERENCE TO RELATED APPLICATIONS

This application is based upon and claims the benefit of priority from the prior Japanese Patent Application No. 2001-278283, filed Sep. 13, 2001, the entire contents of which are incorporated herein by reference.

### BACKGROUND OF THE INVENTION

1. Field of the Invention

The present invention relates generally to an electronic device with a relay function for relaying between a radio terminal device and a network, and more particularly to a technique on an access point having a function of monitoring a security state of radio communication packets.

2. Description of the Related Art

In these years, the construction of a wireless network based mainly on wireless LAN standards of IEEE802.11 has been promoted. The wireless network comprises a plurality of radio terminals and a network connection apparatus called an access point (hereinafter referred to as “access point” or “AP”). The radio terminal has a radio communication function. For example, the radio terminal is a personal computer, or a mobile information device (PDA) that may be a mobile phone. The AP has a relay function for relaying between a terminal device such as a personal computer, and a main network. Specifically, the AP performs radio communication with a personal computer and relays data from the personal computer to a wired LAN that is a main network, and vice versa.

The access point has a function of sending, to peripheral radio terminals, ID information called ESSID (Extended Service Set Identity) for identifying a group of plurality of access points. Using the ESSID sent from the access point, the radio terminal can connects to a desired access point. By this structure, the radio terminal can connect by radio to an access point and perform data communication with a desired wireless LAN.

The wireless LAN standards of IEEE802.11 specify, as an optional function, an encryption function for a data packet (radio communication packet), which is called WEP (Wired Equivalent Privacy). When the WEP function is used, the ESSID and WEP are set to accord to each other, thereby permitting the radio terminal to connect to a desired access point.

In short, when the access point is set in a WEP-applied state, the radio terminal (the terminal accessible to the wireless LAN) needs to be set in a WEP-applied state. On the other hand, when the access point is a WEP-non-applied state, the radio terminal needs to be set in a WEP-non-applied state. However, even if the access point is set in the WEP-applied state, it is possible to construct the access point that has a function of executing communication with the radio terminal in the WEP-non-applied state.

The application of WEP means that packet data is encrypted to enhance data security (the function of avoiding tapping by a third person) in radio communication between the radio terminal and the access point. Since the security in the wireless LAN is important, the access point to which WEP is applied is generally used. However, there is a large demand for communication services that do not require high-level security.

Accordingly, it is desirable to use an access point that can handle either a radio communication packet to which WEP is applied, or a radio communication packet to which WEP is not applied. However, in the prior art, there is no access point that can selectively use the communication service with high-level security and the communication service with not high security, depending on the application/non-application of the WEP.

### BRIEF SUMMARY OF THE INVENTION

The object of the present invention is to realize various communication service functions by effecting switching between a communication service with high-level security and a communication service with not high security, making use of a function of encrypting radio communication packets.

According to an aspect of the invention, there is provided an electronic device such as an access point having a function of checking application/non-application (turn on/off) of an encryption function (e.g. WEP) in each of radio communication packets, and determining a communication service for a packet on the basis of the application/non-application.

The invention may provide an electronic device having a terminal device with a radio communication function, and a relay function for radio data communication between the terminal device and a communication device, the electronic device comprising: a radio section which performs radio communication with the terminal device; determination means for determining whether an encryption function is applied to communication data sent from the terminal device via the radio section; and communication processing means for limiting a transmission destination, to which the communication data is to be transmitted, on the basis of a determination result of the determination means.

With this structure, it is realized to use an access point capable of handling both a radio communication packet, to which an encryption function has been applied, and a radio communication packet, to which the encryption function has not been applied. Moreover, for example, a communication service with high-level security and a communication service with not high security can be selectively carried out, depending on whether an encryption function has been applied to each radio communication packet.

### BRIEF DESCRIPTION OF THE SEVERAL VIEWS OF THE DRAWING

FIG. 1 is a block diagram showing a hardware construction of a system relating to an embodiment of the present invention;

FIG. 2 illustrates a software structure relating to the embodiment;

FIG. 3 is a flow chart illustrating a packet transmission/reception procedure relating to the embodiment;

FIG. 4 illustrates the format of a communication packet relating to the embodiment;

FIG. 5 is a flow chart illustrating a packet transmission/reception procedure relating to a modification 1 of the embodiment; and

FIG. 6 is a flow chart illustrating a packet transmission/reception procedure relating to a modification 2 of the embodiment.

### DETAILED DESCRIPTION OF THE INVENTION

An embodiment of the present invention will now be described with reference to the accompanying drawings.

(Structure of System)

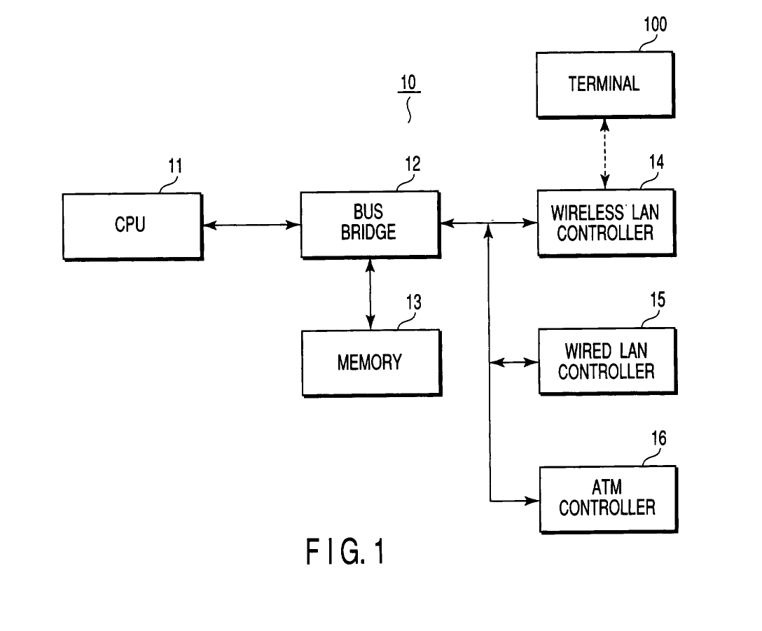

FIG. 1 is a block diagram showing the structure of a system 10 of an access point relating to an embodiment of the present invention. The system 10 is equivalent to a base station for relaying data communication of a wireless LAN or a wired LAN. In other words, the system 10 corresponds to a network connection apparatus having a relay function for a data communication relay between a radio terminal with a radio communication function and a network, in particular, a wireless LAN, a wired LAN, or the Internet.

In FIG. 1, a CPU 11 executes programs loaded in a memory 13 and realizes a relay function of a wireless LAN or a wired LAN. Specifically, the CPU 11 controls a wireless LAN controller 14, a wired LAN (e.g. Ethernet (trademark)) controller 15, and an ATM (Asynchronous Transfer Mode) controller 16.

A bus bridge 12 executes a relay between the communication of the CPU 11, the communication of each of the wireless LAN controller 14, wired LAN controller 15 and ATM controller 16, and the communication of the memory 13. In other words, the bus bridge 12 monitors a CPU bus, a memory bus, and, e.g. a PCI bus connected to each controller 14, 15, 16, and manages data transmission/reception between the buses.

The memory 13 stores programs for controlling the operations of the CPU 11, and also temporarily stores communication packets (hereinafter called simply “packets”) between the wireless LAN controller 14, wired LAN controller 15 and ATM controller 16.

The wireless LAN controller 14 is designed according to, e.g. IEEE802.11b standards, and manages radio data communication with a radio terminal 100 connected to a wireless LAN. The radio terminal 100 is, for example, a personal computer, or a mobile information device (e.g. a mobile phone). The wired LAN controller 15 manages communication through the wired LAN port, and manages data communication with, e.g. a main network constituted by a wired LAN in offices, etc. The ATM controller 16 manages communication through an ATM port, e.g. data communication with the Internet. (Software Structure) The software structure of the system 10 according to the embodiment will now be described.

The present system is classified into a LAN-side system and a WAN (Wide Area Network)-side system. The software of the LAN-side system comprises a bridge processing section 21, a MAC (Media Access Control) address management table 22, a wireless LAN (WLAN) packet processing section 23, a wireless LAN driver 24, a wired LAN driver 25, an IP (Internet Protocol) processing section 26, and a user authentication processing section 27.

The bridge processing section 21 performs a communication packet transfer process via the WLAN packet processing section 23 between the wireless LAN driver 24, wired LAN driver 25 and IP processing section 26. The bridge processing section 21 accesses the MAC address management table 22 and manages information on association between the MAC address and communication port. The MAC address management table 22 constitutes a management table for managing MAC addresses (transmission originating point and destination point). In this embodiment, the MAC address management table 22 is a database for providing relational information for designating communication ports to which the radio terminal 100 and the communication terminal at the other end are connected.

The WLAN packet processing section 23 has a function of checking the application/non-application of the encryption function (WEP) for the communication packet (wireless LAN packet) received by the wireless LAN driver 24 (as will be described later). The WLAN packet processing section 23 to the MAC address management table 22, and controls permission/non-permission of the communication packet.

The wireless LAN driver 24 controls radio data communication with the radio terminal 100. The wireless LAN driver 24 has a function of decrypting the encrypted data of the communication packet to which the encryption function (WEP) is applied. The wired LAN driver 25 controls data communication with the terminal (e.g. personal computer) to which the wired LAN driver 25 is connected via the wired LAN.

The IP (Internet Protocol) processing section 26 controls an IP packet transfer process between the bridge processing section 21 and WAN-side system 12. The IP processing section 26 confirms an IP address assigned to the present system (apparatus). The IP processing section 26 has a function of assigning, where necessary, the packet processing to the user authentication processing section 27 or to some other communication protocol control processing section. The user authentication processing section 27 cooperates with the IP processing section 26 to execute an authentication process requested by the radio terminal 100.

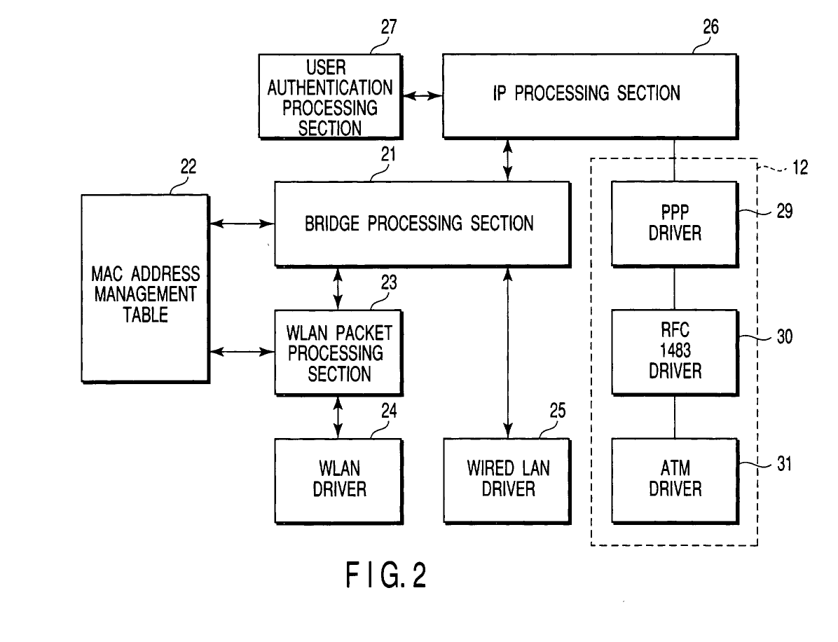

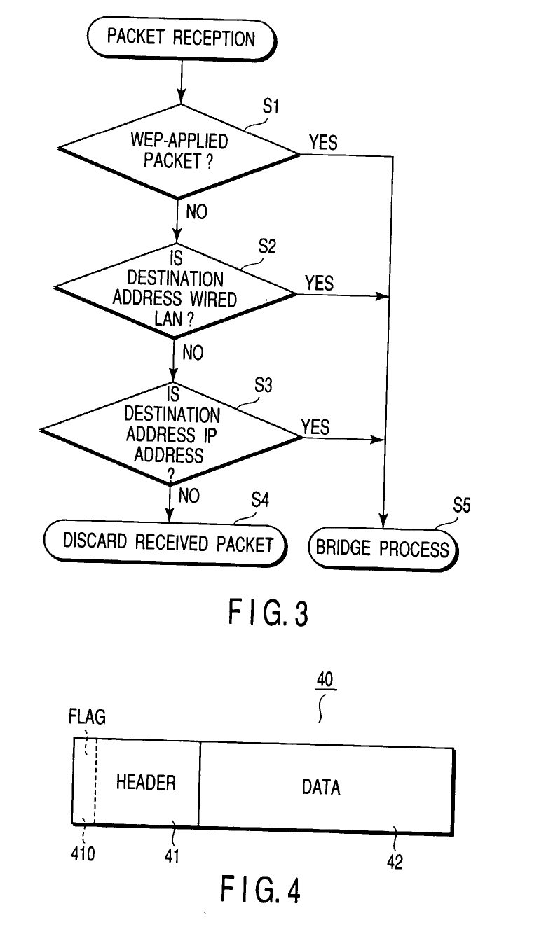

The WAN-side system 12 comprises, e.g. a PPP (Point to Point Protocol) driver 29, an RFC (Request for Comments) 1483 driver 30, and an ATM driver 31. The WAN-side system 12 is connected to the Internet. The PPP driver 29 controls communication with the server that is connected via the ATM driver 31. The RFC 1483 driver 30 controls communication between the PPP driver 29 and ATM driver 31. The ATM driver 31 controls the ATM controller 16 and executes a communication packet transfer control with the Internet. (Communication Process Procedure for Communication Packet) A communication procedure between the access point and the radio terminal according to the embodiment will now be described, mainly, with reference to FIG. 2, a flow chart of FIG. 3, and FIG. 4.

In this embodiment, assume that the radio terminal 100 connects to the access point, and has a function of selecting application/non-application of an encryption function when a communication packet is to be sent. Specifically, as shown in FIG. 4, a communication packet 40 generally comprises a header section 41 that records a MAC address, etc., and a data payload section 42. In this embodiment, assume that the encryption function is, e.g. a WEP (Wired Equivalent Privacy) function that is an optional function of a wireless LAN standard according to IEEE802.11. The communication packet 40 has a WEP flag 410 included in the header section 41, which is ID information indicating application/non-application of the WEP function. If the WEP function is applied and the data in the data payload section 42 is encryption data, the WEP flag 410 is turned on (logic “1”). If the WEP function is not applied, the WEP flag 410 is turned off (logic “0”).

Radio communication between the radio terminal 100 and access point is established by activating communication software of the radio terminal 100. If the wireless LAN driver 24 receives a communication packet from the radio terminal 100, it delivers the packet to the WLAN packet processing section 23. As illustrated in FIG. 3, the WLAN packet processing section 23 determines whether the WEP function has been applied to the received communication packet (step S1). In other words, as mentioned above, the WLAN packet processing section 23 determines application/non-application of the WEP function by checking the on/off state of the WEP flag 410 included in the header section 41.

The WLAN packet processing section 23 refers to the MAC address management table 22 if the determination result shows that the WEP function is not applied to the communication packet. Then, the WLAN packet processing section 23 determines whether the destination MAC address of the communication packet coincides with the address of the node connected to the wired LAN port (“NO” in step S1, S2). Specifically, it is determined whether the destination of the communication packet is at the node connected to the wired LAN port. If the determination result shows that the destination address of the communication packet is not at the LAN node connected to the wired LAN port, the control advances to a process of determining the destination IP address (“NO” in step S2, S3).

The WLAN packet processing section 23 determines whether the destination IP address of the communication packet is the IP address assigned to the present system (apparatus). If the determination result shows that the destination IP address of the communication packet is not assigned to the system, the WLAN packet processing section 23 executes a process of discarding the communication packet (received packet) (prohibition of transfer) (“NO” in step S3, S4).

On the other hand, when the WEP function is applied to the received communication packet, the WLAN packet processing section 23 delivers the communication packet (received packet) to the bridge processing section 21 (“YES” in step S1, S5). The encrypted data (42) of the communication packet is decrypted to the original data by the wireless LAN driver 24. Specifically, the WEP function means that packet data is encrypted to enhance data security (the function of avoiding tapping by a third person) in radio communication between the radio terminal and the access point. Needless to say, the wireless LAN driver 24 executes only the decryption process for the WEP function, and does not execute a decryption process even when the original data itself is encrypted.

In this embodiment, the bridge processing section 21 refers to the MAC address management table 22 and transfers the communication packet to the wired LAN port without fail, if the destination MAC address of the communication packet, to which the WEP function is applied, is at the node connected to the wired LAN port. In short, the communication packet, to which the WEP function is applied, is permitted to be transferred to the wired LAN port.

The WLAN packet processing section 23 delivers the communication packet (received packet) to the bridge processing section 21 if the destination MAC address is present at the node connected to the wired LAN port, even where the WEP function is not applied to the received communication packet (“YES” in step S2, S5). In addition, the WLAN packet processing section 23 delivers the communication packet (received packet) to the bridge processing section 21 if the destination IP address is included in the designated IP address, even where the WEP function is not applied to the received communication packet (“YES” in step S3, S5).

In brief, according to the present embodiment, the WLAN packet processing section 23 and bridge processing section 21 can switch the communication process for the communication packet, depending on the application/non-application of WEP to the communication packet sent from the radio terminal 100. Specifically, the communication packet, to which the WEP function is applied, is transferred to the wired LAN connected to the wired LAN port, and the communication packet, to which the WEP function is not applied, is discarded. In this way, communication services with high-level security can be realized. On the other hand, even where the WEP function is not applied, the communication packet can be transferred to the wired LAN connected to the wired LAN port only by checking the destination MAC address. In addition, the communication packet can be transferred to the IP processing section 26 only by checking the destination IP address. The IP processing section 26 can execute a process to send the communication packet to the destination node connected, e.g. to the Internet via the ATM driver 31.

Therefore, it is possible to avoid fixed communication services by applying or not applying the WEP function, and to realize various communication services such as a communication service with high-level security and a communication service with not high security.

(Modification 1)

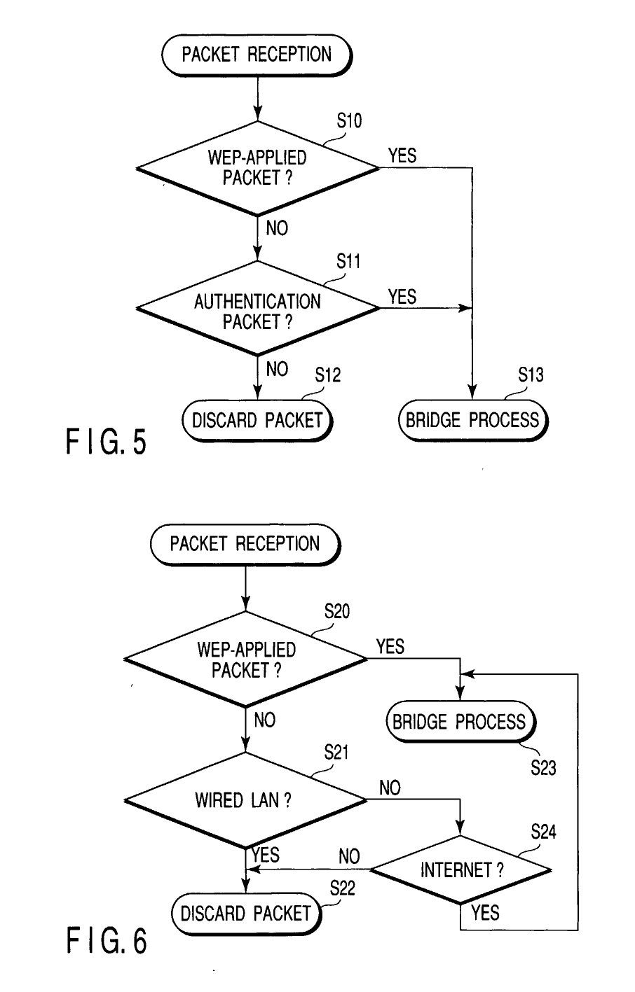

FIG. 5 is a flow chart relating to a modification of the embodiment. This modification relates to a communication service function of transferring the communication packet to the user authentication processing section 27 via the IP processing section 26, if the communication packet is an authentication packet, even if the WEP function is not applied to the communication packet. The modification will now be described in more detail.

The WLAN packet processing section 23, as shown in FIG. 5, determines whether the WEP function is applied to the received communication packet (step S10). If the determination result shows that the WEP function is not applied to the communication packet, the WLAN packet processing section 23 determines whether the communication packet is an authentication packet (“NO” in step S10, S11). If the determination result shows that the communication packet is not an authentication packet, the WLAN packet processing section 23 executes a process of discarding the communication packet (received packet) (prohibition of transfer) (“NO” in step S11, S12).

On the other hand, if the WEP function is applied to the received communication packet, the WLAN packet processing section 23 delivers the communication packet (received packet) to the bridge processing section 21 (“YES” in step S10, S13). Even if the WEP function is not applied to the received communication packet, if the communication packet is the authentication packet, the WLAN packet processing section 23 delivers the communication packet (received packet) to the bridge processing section 21 (“YES” in step S11, S13).

The bridge processing section 21 refers to the MAC address management table 22 and transfers the communication packet to the wired LAN port without fail, if the destination MAC address of the communication packet, to which the WEP function is applied, is at the node connected to the wired LAN port. In short, only the communication packet, to which the WEP function is applied, is permitted to be transferred to the wired LAN port.

On the other hand, even if the WEP function is not applied to the communication packet, if the communication packet is the authentication packet, the bridge processing section 21 transfers the communication packet to the IP processing section 26. Thus, the user authentication processing section 27 executes the authentication process requested by the radio terminal 100, using the authentication packet delivered from the IP processing section 26. In short, even if the WEP function is not applied to the communication packet, it is possible to realize a communication service wherein the authentication process requested by the radio terminal 100 is executed without fail.

(Modification 2)

FIG. 6 is a flow chart relating to another modification of the embodiment. This embodiment relates to a communication service function wherein distinction is made between a user who is permitted to use resources, in particular, printers and shared files connected to a wired LAN, and a user (a user with guest authentication) who is permitted to use them with limitations, on the basis of the application/non-application of the WEP to the communication packet. The modification will now be described in greater detail.

The WLAN packet processing section 23, as shown in FIG. 6, determines whether the WEP function is applied to the received communication packet (step S20). If the determination result shows that the WEP function is applied to the received communication packet, the WLAN packet processing section 23 delivers the communication packet to the bridge processing section 21 (“YES” in step S20, S23). The bridge processing section 21 refers to the MAC address management table 22 and transfers the communication packet to the wired LAN port without fail, if the destination MAC address of the communication packet, to which the WEP function is applied, is at the node connected to the wired LAN port. Thereby, the user of the radio terminal, who sent the communication packet to which the WEP function is applied, can make use of printers and shared files connected to the wired LAN.

On the other hand, if the determination result shows that the WEP function is not applied to the communication packet, the WLAN packet processing section 23 refers to the MAC address management table 22. Then, the WLAN packet processing section 23 determines whether the destination MAC address of the communication packet coincides with the address of the node connected to the wired LAN port (“NO” in step S20, S21). If the determination result shows that the destination of the communication packet is at the node connected to the wired LAN port, the WLAN packet processing section 23 executes a process of discarding the communication packet (“YES” in step S21, S22).

If the destination IP address of the communication packet is the IP address assigned to the present system (apparatus), the WLAN packet processing section 23 delivers the communication packet to the bridge processing section 21. The IP processing section 26 executes a process to send the communication packet from the bridge processing section 21 via the ATM driver 31 to the destination node connected to the Internet (“NO” in step S21, “YES” in step S24).

In short, in this modification, it is possible to realize the communication service for making distinction between a user who is permitted to use resources such as printers and shared files connected to a wired LAN, and a user (a user with guest authentication) who is permitted to use them with limitations, on the basis of the application/non-application of the WEP to the communication packet. In this case, the user with guest authentication is unable to use resources such as printers and shared files connected to the wired LAN, but he/she can enjoy Internet connection services.

As has been described in detail, according to the present invention, various communication service functions can be realized, in particular, in electronic devices with a network relay function for relaying with a radio terminal. For example, a communication service with high-level security and a communication service with not high security can be switched, making use of a function of encrypting radio communication packets.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic device which communicates with a first device and a second device, comprising:
a first communication module configured to communicate with the first device;
a second communication module configured to communicate the second device;
a relay function configured to communicate data between the first device and the second device;
means for determining whether data sent from the first device is encrypted; and
a processor configured to control the relay function to allow transmission of the data sent from the first device to the second device according to the determining means.

2. The device according to claim 1, wherein the first communication module performs radio communication with the first device.

3. The device according to claim 2, wherein the determining means determines whether the data sent from the first device is encrypted in each packet, and the processor controls the relay function to limit the transmission of the each packet according to the determining means.

4. The device according to claim 2, wherein the processor discards the packet included in the data sent from the first device when the packet is not encrypted.

5. The device according to claim 2, further comprising a wired LAN port connected to the relay function,
wherein the processor prohibits transmission of the data to the wired LAN port when the data is not encrypted.

6. The device according to claim 2, further comprising
a wired LAN port connected to the relay function configure to communicate with a device connected to the LAN, and
a public port connected to the relay function configured to communicate with a public network,
wherein the processor prohibits transmission of the data to the wired LAN port when the data is not encrypted.

7. The device according to claim 2, wherein the processor permits the relay function to transmit the data including an authentication process nevertheless the data is not encrypted.

8. A communication method applied to an electronic device which communicates with a first device and a second device, the method comprising;
receiving data transmitted from the first device;
determining whether the data sent from the first device is encrypted; and
deciding whether the data sent from the first device is transmitted to the second device according to the determining step.

9. A communication method applied to an electronic device which communicates with a first device and a second device, the method comprising;
receiving data transmitted from the first device;
determining whether the data sent from the first device is encrypted; and
controlling the data whether discarding the packet when the packet is not encrypted or executing a predetermined process communication process for the packet when the packet is encrypted according to the determined result.

10. An electronic device having a first device with a radio communication function, comprising:
a relay function configured to communicate data between the first device and a second device;
a radio section which performs radio communication with the first device;
first communication means for performing communication with said second device;
second communication means, different from said first communication means, for performing communication with said second device;
determination means for determining whether data sent from the first device via the radio section is encrypted; and
communication processor for prohibiting, when said determination means determines that the data is encrypted, transmission of the data to the first communication means and permitting transmission of the data to the second communication means.

11. The device according to claim 10, wherein said determination means determines whether the data sent from the first device is encrypted in each packet, and
said processor controls the relay function to limit the transmission of the each packet according to the determination means.
